(19) United States
(12) Patent Application Publication
(10) Pub. No.: US 2022/0382638 A1
(43) Pub. Date: Dec. 1, 2022

(54) Method and Apparatus for Creating Recovery Point Objectives in Persistent Memory

(71) Applicant: EMC IP HOLDING COMPANY LLC, Hopkinton, MA (US)

(72) Inventors: Owen Martin, Hopedale, MA (US); John Creed, Innishannon (IE)

(21) Appl. No.: 17/303,506

(22) Filed: Jun. 1, 2021

(51) Int. Cl. G06F 11/14; G06F 3/06; G06F 9/455

(52) U.S. Cl. CPC G06F 11/1448; G06F 3/0655; G06F 3/0644; G06F 9/45558; G06F 3/0679; G06F 2009/45583

(57) ABSTRACT

A virtual memory mapping table includes snapshot instance identifiers of data volumes stored in memory regions of persistent memory. If a write operation occurs to an occupied memory region of persistent memory, a snapshot instance identifier of the write operation is compared with the snapshot instance identifier of the data stored at the memory region of persistent memory. If the snapshot instance identifiers are the same, the write operation overwrites the current version of the data at the memory region. If the snapshot instance identifiers are not the same, the write operation causes the current version of the data that is stored at the memory region of persistent memory to be written to a snapshot repository, and the new data is then written to the memory region of persistent memory. A new cache flush instruction is introduced that causes replication of existing data in persistent memory to the snapshot repository.

### FIELD

This disclosure relates to computing systems and related devices and methods, and, more particularly, to a method and apparatus for creating recovery point objectives in persistent memory.

### SUMMARY

The following Summary and the Abstract set forth at the end of this document are provided herein to introduce some concepts discussed in the Detailed Description below. The Summary and Abstract sections are not comprehensive and are not intended to delineate the scope of protectable subject matter, which is set forth by the claims presented below.

All examples and features mentioned below can be combined in any technically possible way.

A virtual memory mapping table includes snapshot instance identifiers of tracks of data stored in memory regions of persistent memory. If a write operation occurs to an occupied memory region of persistent memory, a snapshot instance identifier of the write operation is compared with the snapshot instance identifier of the data stored at the memory region of persistent memory. If the snapshot instance identifiers are the same, the write operation overwrites the current version of the data at the memory region. If the snapshot instance identifiers are not the same, the write operation causes the current version of the data that is stored at the memory region of persistent memory to be written to a snapshot repository, and the new data is then written to the memory region of persistent memory. A new cache flush instruction is introduced that causes replication of existing data in persistent memory to the snapshot repository.

### BRIEF DESCRIPTION OF THE DRAWINGS

FIG. 1 is a functional block diagram of an example storage system connected to a host computer, according to some embodiments.

FIG. 2 is a functional block diagram of an example storage system configured to implement local replication of persistent memory, according to some embodiments.

FIGS. 3 and 4 are timelines showing example sets of operations on a cache, persistent memory, and snapshot repository, according to some embodiments.

FIG. 5 is a functional block diagram of a virtual memory mapping table data structure showing an example mapping between tracks of a customer-provisioned storage volume and memory regions of persistent memory, according to some embodiments.

FIG. 6 is a functional block diagram showing an example set of operations on the virtual memory mapping table in connection with an example write operation that causes local replication of persistent memory, according to some embodiments.

FIG. 7 is a functional block diagram of an example data structure showing a region of an example virtual memory mapping table at a first point in time, according to some embodiments.

FIG. 8 is a functional block diagram of the example data structure of FIG. 7 showing the region of the example virtual memory mapping table at a second point in time, according to some embodiments.

FIG. 9 is a functional block diagram of an example data structure showing a second region of an example virtual memory mapping table containing metadata associated with tracks of snapshot data stored in a snapshot repository, according to some embodiments.

FIG. 10 is a functional block diagram of several data structures showing construction of a snapshot, where a first portion of the snapshot data is stored in persistent memory and a second portion of the snapshot data is stored in a snapshot repository, according to some embodiments.

FIG. 11 is a flow chart of an example process of implementing a write operation to persistent memory, according to some embodiments.

FIG. 12 is a flow chart of an example process of implementing a snapshot read operation where recovery point objectives are implemented using local replication of persistent memory, according to some embodiments.

### DETAILED DESCRIPTION

Aspects of the inventive concepts will be described as being implemented in a storage system 100 connected to a host computer 102. Such implementations should not be viewed as limiting. Those of ordinary skill in the art will recognize that there are a wide variety of implementations of the inventive concepts in view of the teachings of the present disclosure.

Some aspects, features and implementations described herein may include machines such as computers, electronic components, optical components, and processes such as computer-implemented procedures and steps. It will be apparent to those of ordinary skill in the art that the computer-implemented procedures and steps may be stored as computer-executable instructions on a non-transitory tangible computer-readable medium. Furthermore, it will be understood by those of ordinary skill in the art that the computer-executable instructions may be executed on a variety of tangible processor devices, i.e., physical hardware. For ease of exposition, not every step, device or component that may be part of a computer or data storage system is described herein. Those of ordinary skill in the art will recognize such steps, devices and components in view of the teachings of the present disclosure and the knowledge generally available to those of ordinary skill in the art. The corresponding machines and processes are therefore enabled and within the scope of the disclosure.

The terminology used in this disclosure is intended to be interpreted broadly within the limits of subject matter eligibility. The terms “logical” and “virtual” are used to refer to features that are abstractions of other features, e.g. and without limitation, abstractions of tangible features. The term “physical” is used to refer to tangible features, including but not limited to electronic hardware. For example, multiple virtual computing devices could operate simultaneously on one physical computing device. The term “logic” is used to refer to special purpose physical circuit elements, firmware, and/or software implemented by computer instructions that are stored on a non-transitory tangible computer-readable medium and implemented by multi-purpose tangible processors, and any combinations thereof.

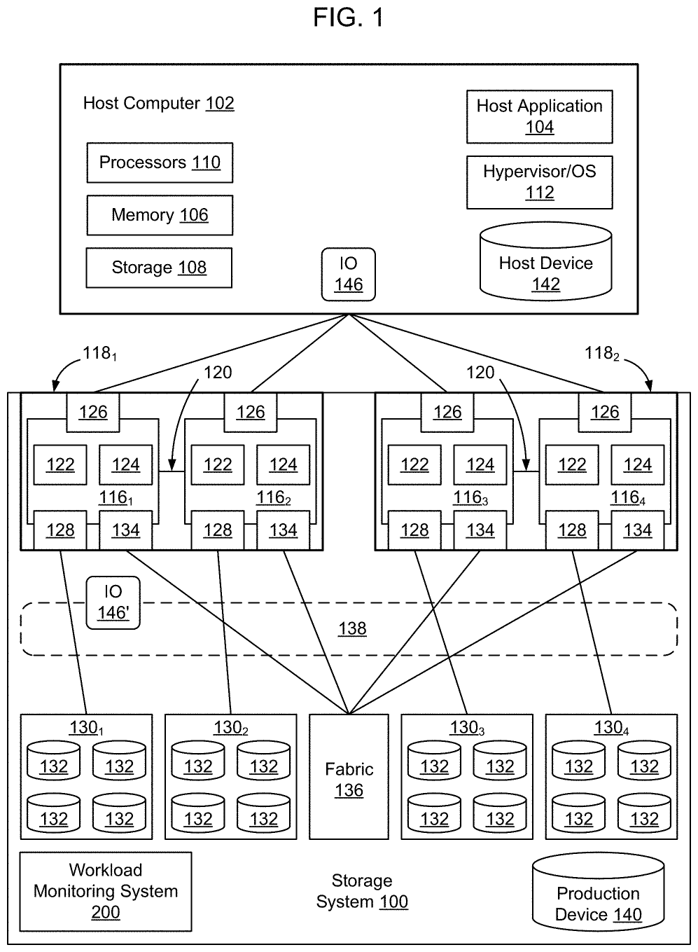

FIG. 1 illustrates a storage system 100 and an associated host computer 102, of which there may be many. The storage system 100 provides data storage services for a host application 104, of which there may be more than one instance and type running on the host computer 102. In the illustrated example, the host computer 102 is a server with host volatile memory 106, persistent storage 108, one or more tangible processors 110, and a hypervisor or OS (operating system) 112. The processors 110 may include one or more multi-core processors that include multiple CPUs, GPUs, and combinations thereof. The host volatile memory 106 may include RAM (Random Access Memory) of any type. The persistent storage 108 may include tangible persistent storage components of one or more technology types, for example and without limitation Solid State Drives (SSDs) and Hard Disk Drives (HDDs) of any type, including but not limited to SCM (Storage Class Memory), EFDs (enterprise flash drives), SATA (Serial Advanced Technology Attachment) drives, and FC (Fibre Channel) drives. The host computer 102 might support multiple virtual hosts running on virtual machines or containers. Although an external host computer 102 is illustrated in FIG. 1, in some embodiments host computer 102 may be implemented in a virtual machine within storage system 100.

The storage system 100 includes a plurality of compute nodes 116₁-116₄, possibly including but not limited to storage servers and specially designed compute engines or storage directors for providing data storage services. In some embodiments, pairs of the compute nodes, e.g. (116₁-116₂) and (116₃-116₄), are organized as storage engines 118₁ and 118₂, respectively, for purposes of facilitating failover between compute nodes 116 within storage system 100. In some embodiments, the paired compute nodes 116 of each storage engine 118 are directly interconnected by communication links 120. As used herein, the term “storage engine” will refer to a storage engine, such as storage engines 118₁ and 118₂, which has a pair of (two independent) compute nodes, e.g. (116₁-116₂) or (116₃-116₄). A given storage engine 118 is implemented using a single physical enclosure and provides a logical separation between itself and other storage engines 118 of the storage system 100. A given storage system 100 may include one storage engine 118 or multiple storage engines 118.

Each compute node, 116₁, 116₂, 116₃, 116₄, includes processors 122 and a local volatile memory 124. The processors 122 may include a plurality of multi-core processors of one or more types, e.g. including multiple CPUs, GPUs, and combinations thereof. The local volatile memory 124 may include, for example and without limitation, any type of RAM. Each compute node 116 may also include one or more front end adapters 126 for communicating with the host computer 102. Each compute node 116₁-116₄ may also include one or more back-end adapters 128 for communicating with respective associated back end drive arrays 130₁-130₄, thereby enabling access to managed drives 132.

In some embodiments, managed drives 132 are storage resources dedicated to providing data storage to storage system 100 or are shared between a set of storage systems 100. Managed drives 132 may be implemented using numerous types of memory technologies for example and without limitation any of the SSDs and HDDs mentioned above. In some embodiments the managed drives 132 are implemented using Non-Volatile Memory (NVM) media technologies, such as NAND-based flash, or higher-performing Storage Class Memory (SCM) media technologies such as 3D XPoint and Resistive RAM (ReRAM). Managed drives 132 may be directly connected to the compute nodes 116₁-116₄, using a PCIe bus or may be connected to the compute nodes 116₁-116₄, for example, by an InfiniBand (IB) bus or fabric.

In some embodiments, each compute node 116 also includes one or more channel adapters 134 for communicating with other compute nodes 116 directly or via an interconnecting fabric 136. An example interconnecting fabric 136 may be implemented using InfiniBand. Each compute node 116 may allocate a portion or partition of its respective local volatile memory 124 to a virtual shared “global” memory 138 that can be accessed by other compute nodes 116, e.g. via Direct Memory Access (DMA) or Remote Direct Memory Access (RDMA).

The storage system 100 maintains data for the host applications 104 running on the host computer 102. For example, host application 104 may write data of host application 104 to the storage system 100 and read data of host application 104 from the storage system 100 in order to perform various functions. Examples of host applications 104 may include but are not limited to file servers, email servers, block servers, and databases.

Logical storage devices are created and presented to the host application 104 for storage of the host application 104 data. For example, as shown in FIG. 1, a production device 140 and a corresponding host device 142 are created to enable the storage system 100 to provide storage services to the host application 104.

The host device 142 is a local (to host computer 102) representation of the production device 140. Multiple host devices 142, associated with different host computers 102, may be local representations of the same production device 140. The host device 142 and the production device 140 are abstraction layers between the managed drives 132 and the host application 104. From the perspective of the host application 104, the host device 142 is a single data storage device having a set of contiguous fixed-size LBAs (logical block addresses) on which data used by the host application 104 resides and can be stored. However, the data used by the host application 104 and the storage resources available for use by the host application 104 may actually be maintained by the compute nodes 116₁-116₄ at non-contiguous addresses (tracks) on various different managed drives 132 on storage system 100.

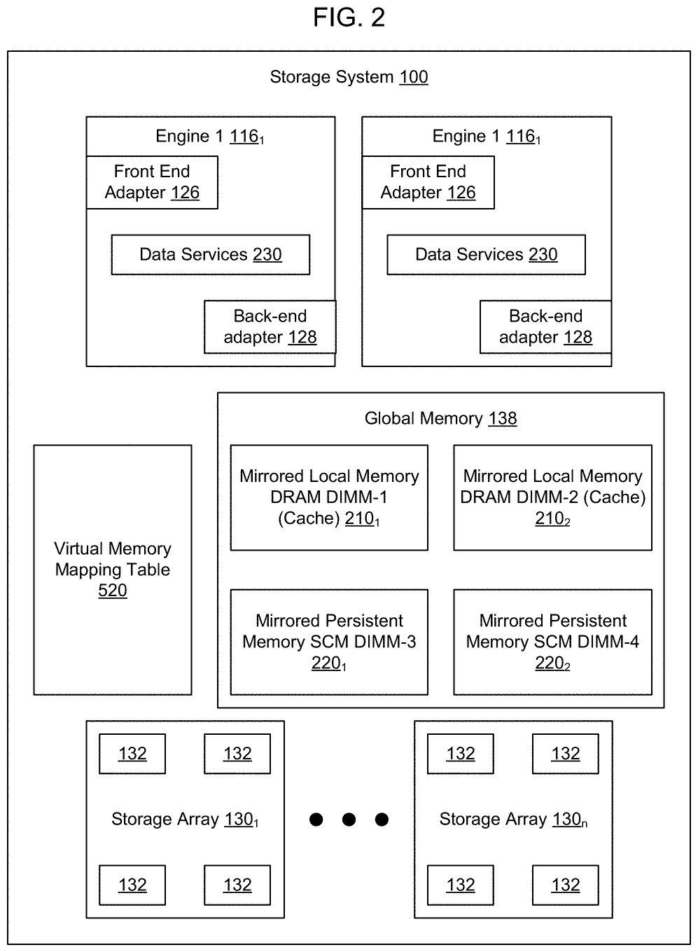

In some embodiments, the storage system 100 maintains metadata that indicates, among various things, mappings between the production device 140 and the locations of extents of host application 104 data in the virtual shared global memory 138 and the managed drives 132. The metadata may be stored in a virtual memory mapping table 520 (see FIG. 2). In response to an IO (input/output command) 146 from the host application 104 to the host device 142, the hypervisor/OS 112 determines whether the IO 146 can be serviced by accessing the host volatile memory 106. If that is not possible then the IO 146 is sent to one of the compute nodes 116 to be serviced by the storage system 100.

In the case where IO 146 is a read command, the storage system 100 uses metadata to locate the commanded data, e.g. in the virtual shared global memory 138 or on managed drives 132. If the commanded data is not in the virtual shared global memory 138, then the data is temporarily copied into the virtual shared global memory 138 from the managed drives 132 and sent to the host application 104 via one of the compute nodes 116₁-116₄. In the case where the IO 146 is a write command, in some embodiments the storage system 100 copies a block being written into the virtual shared global memory 138, marks the data as dirty, and creates new metadata that maps the address of the data on the production device 140 to a location to which the block is written on the managed drives 132.

To provide enhanced reliability, a point in time copy of data of a production device or of a set of production devices may be created. This point-in-time copy may be used as a Recovery Point Objective (RPO) such that, if a failure occurs, the host application may return to the RPO and continue execution from that point in time.

A “snapshot,” as that term is used herein, is a copy of a volume of data as that volume existed at a particular point in time. A snapshot of a production device 140, accordingly, is a copy of the data stored on the production device 140 as the data existed at the point in time when the snapshot was created. Snapshots are used to provide Recovery Point Objectives (RPO) such that, if a fault occurs that results in a loss of data from the production device, or if the production device becomes unavailable for some reason, the snapshot may be loaded and used by the application. Conventionally, snapshots of production devices and snapsets of groups of production devices would be created using block storage on managed drives 132 provided by the storage arrays 130.

In some embodiments, the storage engines 118 of the compute nodes 116 are provided with persistent memory 210, which forms part of the shared global memory 138. The persistent memory 210 may be implemented using Storage Class Memory (SCM), which is faster than the managed drives 132 of storage array 130 and slower than DRAM-based cache of the storage engines 118. However, since SCM is much less expensive than DRAM, it is possible to provide significantly more SCM memory on a given storage engine 118. SCM is also persistent, so that data is not lost during a power loss event. Each storage engine 118 can access the persistent memory of each other storage engine 118 using Remote Direct Memory Access (RDMA) without involving the CPU of the director where the persistent memory is located.

The shift from block storage to persistent memory has created a need for a way to provide a Recovery Point Objective (RPO) for customers. According to some embodiments, synchronous snapshots of persistent memory regions are created which are mapped to hosts. Persistent memory regions are associated with snapshot instance identifiers, which are updated in a virtual memory mapping table. As write operations occur on tracks of a customer-defined storage volume, the snapshot instance identifiers are used to selectively copy memory regions of persistent memory to snapshot repositories, to provide recovery points of the customer-defined storage volumes.

FIG. 2 is a functional block diagram of an example storage system configured to implement local replication of persistent memory, according to some embodiments. As shown in FIG. 2, in some embodiments a storage system has a set of storage engines 118, which are configured to have a DRAM based cache 210 and persistent memory 220. In FIG. 2, the DRAM based cache 210 is shown as being implemented using two mirrored local memory DRAM Dual In-line Memory Module (DIMM) modules 2101, 2102, although multiple DRAM DIMM modules may be used. In FIG. 2, the persistent memory 220 is shown as being implemented using two mirrored local memory SCM DIMM modules 2201, 2202, although multiple SCM DIMM modules may be used.

In some embodiments, the DRAM modules are used to store data for use by the CPUs 122. When data is not required by the CPU, the data can be moved out of cache 210 to persistent memory 220. In some embodiments, a virtual memory architecture is used to enable each storage engine 118 to access the memory of every other storage engine 118 using remote direct memory access, which allows access to the cache 210 and persistent memory 220 without involving the CPU 122 of the engine 118 where the memory is physically located in the storage system.

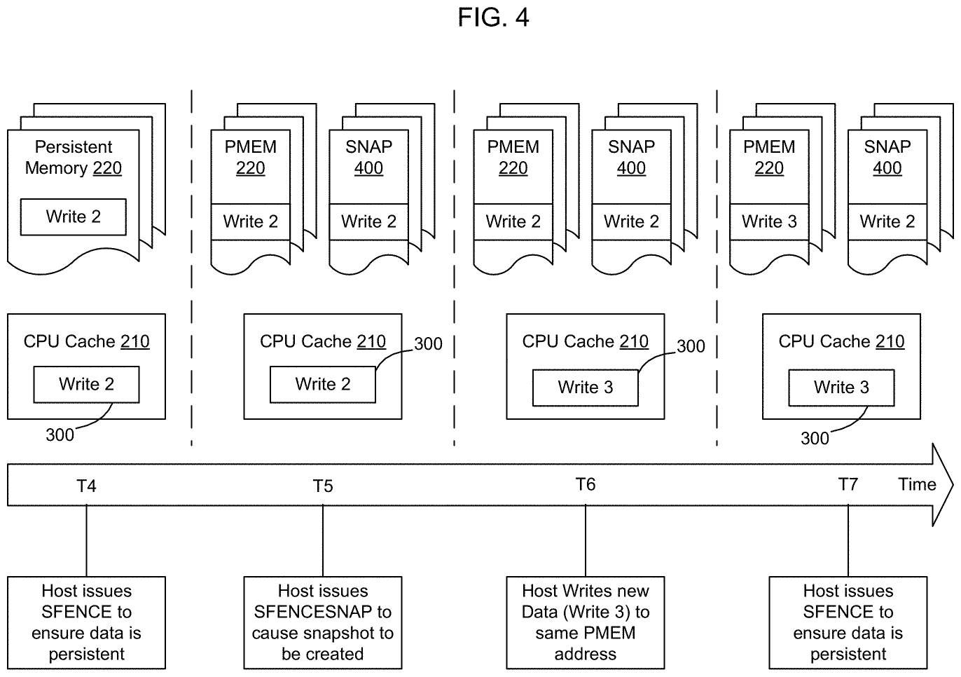

The CPU 122 maintains a virtual memory mapping table 520 (see FIG. 5) which contains metadata correlating virtual addresses of tracks of a customer-defined storage volume 500 with physical addresses of memory regions in persistent memory 220. The CPU has a translation lookaside buffer (TLB) cache which, in some embodiments, is provided to store recently translated virtual addresses so that the memory can be accessed directly without the CPU 122.

There are instances where data that is contained in DRAM (cache) 210 needs to be moved out of cache 210 into persistent memory 220. The existing Intel® persistent memory architecture has instructions that flush memory regions from the CPU cache 210 to persistent memory 220. For example, the command CLFLUSH can be used to move a memory region from cache 210 to persistent memory 220, while the command CLFLUSHOPT can be used to copy a memory region from the cache 210 to persistent memory 220, while keeping a copy of the memory region in cache 210 as well. The command SFENCE provides a memory barrier that causes the CPU to enforce an ordering constraint on memory operations issued before and after the barrier instruction, to ensure ordered writes, which may be used in connection with issuance of a CLFLUSH instruction.

According to some embodiments, a new instruction is provided that will not only flush the memory region from the cache 210 to persistent memory 220, but will also cause a synchronous snapshot of the data that is currently stored in the target memory region of persistent memory to be copied to a snapshot repository 400. In some embodiments, the snapshot repository 400 is implemented using a thin device on managed drives 132 of storage array 130. By causing a snapshot copy of the memory region of persistent memory 220 to be created in a snapshot repository 400 before the memory region is overwritten in connection with flushing a track of data from the cache 210 to persistent memory 220, it is possible to ensure that a consistent version of the customer-defined storage volume at a particular RPO is preserved.

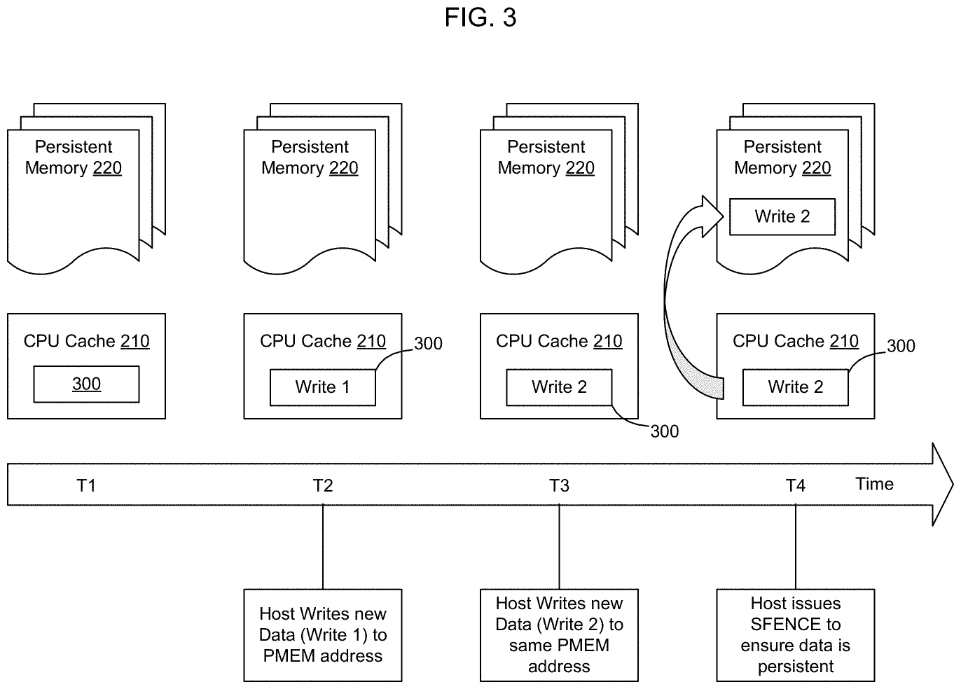

FIGS. 3 and 4 are timelines showing example sets of operations on a cache 210, persistent memory 220, and snapshot repository 400, according to some embodiments. As shown in FIG. 3, at time T1 write W1 to a particular virtual address of a customer-defined storage volume has not yet occurred, so there is no data associated with write W1 in the cache 210 or in persistent memory 220.

At time T2, write W1 is received which is addressed to a particular virtual address. A write operation to a virtual address of a customer-defined storage volume will be referred to herein as a write to a “track” of the customer-defined storage volume. A “track” may be an arbitrary unit of storage, the size of which will depend on the implementation. A given write operation may be associated with multiple tracks of a customer-defined storage volume 500. However, for ease of explanation, the description will focus on how the storage system implements a write operation on a single track of a customer-defined storage volume. It should be understood that this same process can be used in connection with each track of a multi-track write operation on customer-defined storage volume 500.

As shown in FIG. 3, when write W1 on a given track is received, the data associated with write W1 is written to a first memory region in cache 210, but at this stage is not written to persistent memory 220. At time T3, a second write operation is received on the same track which is also directed to the same virtual address of customer-defined storage volume 500. Accordingly, Write 2 is written to the first memory region in cache 210, such that the data associated with Write 1 is replaced with the data associated with Write 2 at the first memory region in cache 210. At time T4, the host issues an operation (SFENCE/CLFLUSH) to flush the data associated with the first memory region to persistent memory 220, which causes Write 2 to be stored at a selected memory region of persistent memory 220.

Conventionally, if a subsequent write were to occur on the same track identified by the same virtual address, issuing a SFENCE/CLFLUSH operation would cause the data stored at the selected address of persistent memory 220 to be overwritten. This prevented the old data that was stored in persistent memory from forming part of a recovery point objective, since each time a memory region associated with a virtual address was flushed from cache 210 to persistent memory 220, the flush operation would cause the old data that was previously stored at that the corresponding location of persistent memory 220 to be replaced with the new data that is currently contained in the memory region of cache 210.

FIG. 4 is a timeline showing an example set of operations on a cache 210 and persistent memory 220 using an instruction configured to create a snapshot of the data that was previously stored in the memory region of persistent memory, as the track of data is flushed from cache 210 to persistent memory 220, according to some embodiments. As shown in FIG. 4, at time T5 the host issues an operation (referred to herein as SFENCESNAP) to both flush the memory region from cache 210 to persistent memory 220, and also create a copy of the data that is currently stored in the memory region of persistent memory in a snapshot repository 400. By creating a copy of the memory region in a snapshot repository 400, it is possible to retain a copy of the previous version of the track of data, to thereby enable creation of a consistent point in time RPO that may be used by the application as a recovery point in the event of a failure.

For example, as shown in FIG. 4, at time T6 a third write operation is received on the track of the customer-defined storage volume 500, which is also directed to the same address in persistent memory. Accordingly, Write 3 is written to the first memory region in cache 210, such that Write 2 is replaced with Write 3 at the first memory region in cache 210. At time T7, the host issues an operation (SFENCE/CLFLUSH) to flush the data associated with the first memory region to persistent memory 220, which causes Write 3 to be stored at the address of persistent memory 220. Note, in connection with this, that issuing the SFENCE/CLFLUSH operation to flush Write 3 from the first memory region of cache 210 to the address of persistent memory 220 will cause the new data Write 3 to replace the old data Write 2 in persistent memory 220. However, the previous version of the data (Write 2) is retained in the snapshot repository 400, which enables the previous version of the data (Write 2) to be accessed, if necessary, to form a recovery point objective for the host application.

FIG. 5 is a functional block diagram of a virtual memory mapping table data structure 520 showing an example mapping between tracks of a customer-provisioned storage volume 500 and memory regions of persistent memory 220, according to some embodiments. As shown in FIG. 5, in some embodiments, Virtual Protocol Interconnect (VPI) metadata management is implemented such that entries of the virtual memory mapping table 520 include snapshot instance identifiers 530. In some embodiments, for each customer-provisioned storage volume 500, the metadata management system defines a label (name of the customer-provisioned storage volume), the size of the customer-provisioned storage volume, and the active snapshot instance. The active snapshot instance is the version that each page will be tagged with, when written. The active snapshot instance can be changed by the customer on demand, or according to a particular schedule, to enable multiple RPOs to be created over time.

Accordingly, as shown in FIG. 5, each customer-provisioned storage volume 500 will be provided with a page in virtual memory mapping table 520. Each entry of the virtual memory mapping table 520 includes a virtual address 540 of the track of the customer-provisioned storage volume 500. The entry also includes a physical address 550, where data associated with the virtual address is stored in memory on the storage system 100, such as in cache 210 or persistent memory 220. The entry also includes a snapshot instance identifier 530. The snapshot instance identifier 530 identifies the snapshot instance associated with the version of the data that is currently stored at the address 550 in physical memory.

In the example shown in FIG. 5, customer-provisioned storage volume number 001 (SV:001) has been provisioned on the storage system 100 which has a size attribute of 1 GB. A write operation associated with snapshot instance 123 has occurred on virtual address: SV001:aa00 which is mapped in the virtual memory mapping table 520 to a memory region in persistent memory 220 on SCM DIMM1 having a physical address 1234 (SCMD1:1234).

Periodically, a new recovery point objective will be specified on a customer-defined storage volume, which will cause all write operations on a host device that occur subsequently to be associated with a new snapshot instance identifier. Specifically, when it is determined that a new recovery point objective should be created on the customer-provisioned storage volume, the snapshot instance identifier associated with the customer-provisioned storage volume will be incremented such that all subsequent write operations on the customer-provisioned storage volume will be assigned the new incremented snapshot instance identifier. When new data is written to tracks of the customer-defined storage volume, the old data with earlier snapshot instance identifiers will be preserved by being written out to a snapshot repository 400, before being replaced in persistent memory 220.

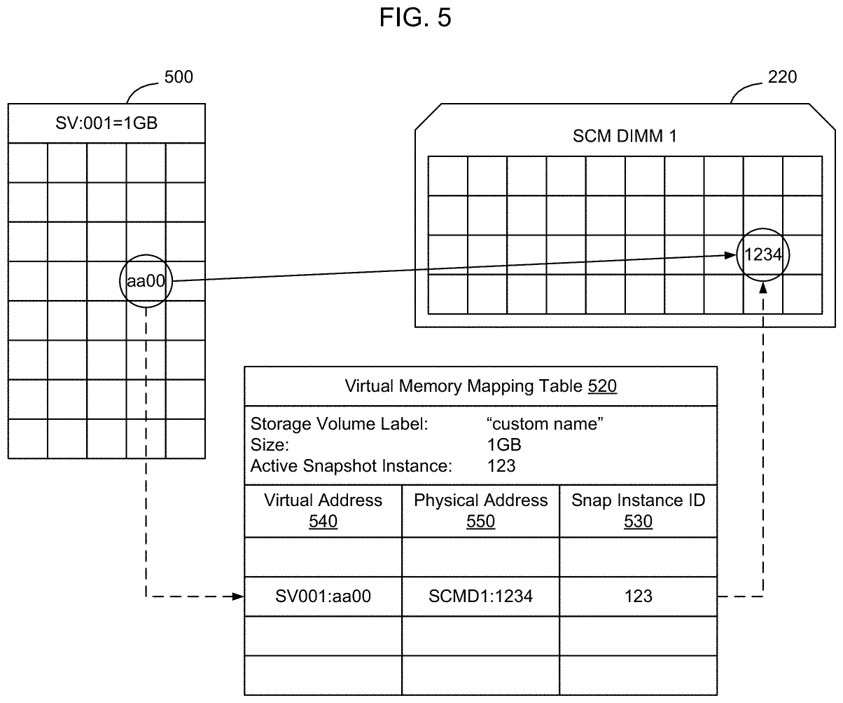

FIG. 6 is a functional block diagram showing an example set of operations on the virtual memory mapping table 520 in connection with an example write operation that causes local replication of a track of data to a snapshot repository, according to some embodiments. In the example shown in FIG. 6, a second write operation associated with snapshot instance 124 has occurred on virtual address: SV001:aa00. The previous data that was stored in the SCM DIMM1 physical address 1234 (SCMD1:1234) has been copied to a snapshot repository 400 for snapshot instance 123 and has a physical address PMEMD1:4321. The new data, with a snapshot instance identifier 124, is then stored at SCM DIMM1 physical address 1234 (SCMD1:1234). In this manner, the previous version of data associated with virtual address SV001:aa00 is able to be preserved in a snapshot repository 400, when a write operation for that virtual address with a more recent snapshot instance identifier is received.

Accordingly, the virtual memory mapping table 520 has two entries 600, 605 for a first memory region SV001:aa00. The first entry 600 is associated with snapshot instance identifier 123, that points to a location (PMEMD1:4321) in snapshot repository 400. The second entry 605 is the more current entry, and is associated with a snapshot instance identifier 124. The second, current, entry 605 points to a location (SCMD1:1234) in persistent memory 220. If a subsequent write operation is received with a new snapshot instance identifier, e.g. snapshot instance identifier 125, the entry 605 will be copied to second snapshot repository and the new version of data associated with memory region SV001:aa00 will be stored at the physical address SCMD1:1234 in persistent memory 220.

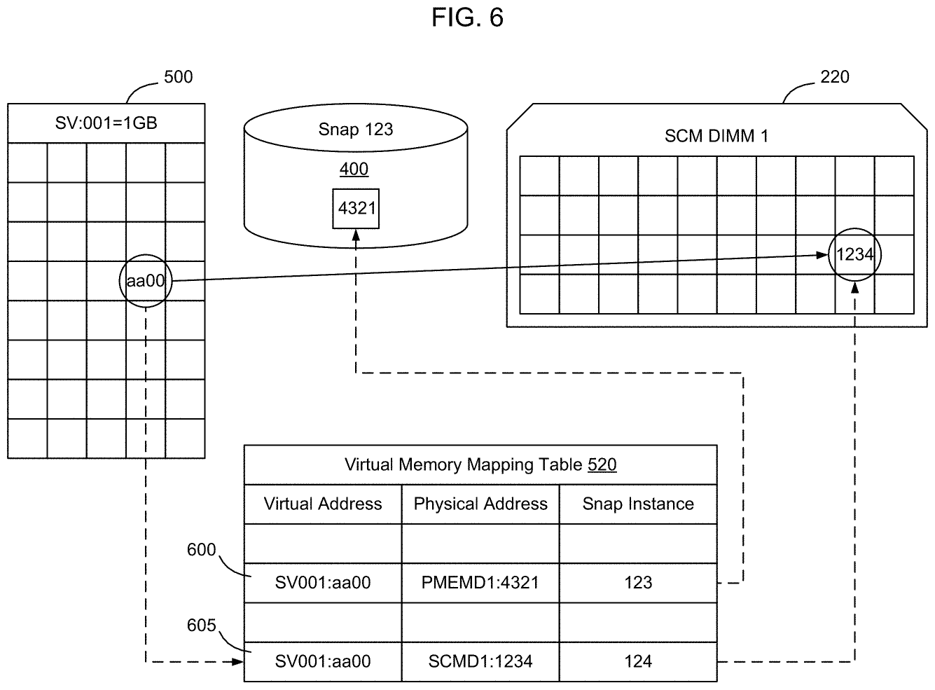

FIG. 7 is a functional block diagram of an example data structure showing a region of an example virtual memory mapping table 520 at a first point in time, according to some embodiments. As shown in FIG. 7, at a first point in time, the virtual memory mapping table 520 has an entry for virtual address with a page ID 58876 which is stored at physical location 375655 in persistent memory 220. The snapshot instance identifier for this version of page ID is 123.

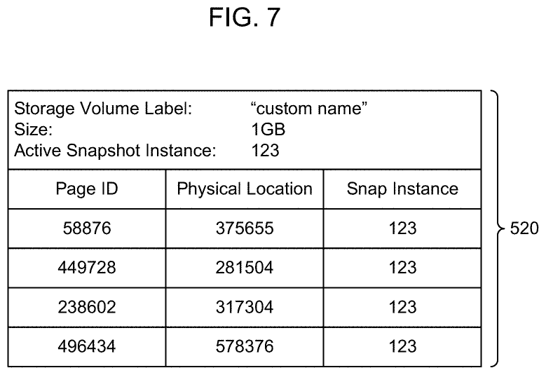

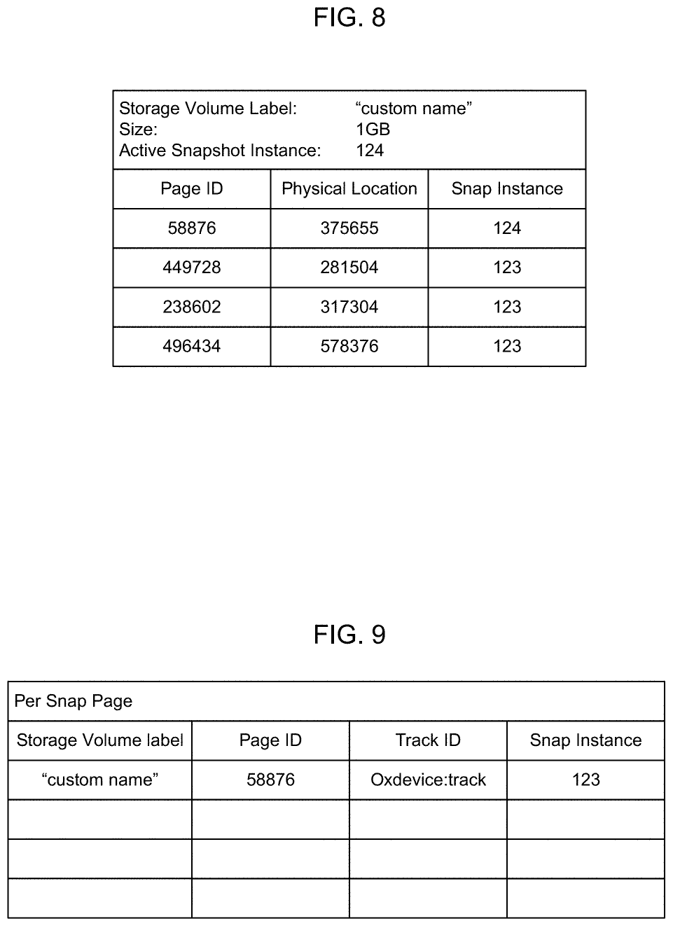

FIG. 8 is a functional block diagram of the example data structure of FIG. 7 showing the region of the example virtual memory mapping table 520 at a second point in time, according to some embodiments. As shown in FIG. 8, when a write operation to page ID 58876 arrives which has a new snapshot instance identifier 124, the data that was previously stored at physical location 375655 is moved to a snapshot repository (see FIG. 9) and the new data for page ID 58876 with snapshot instance identifier 124 is stored at physical location 375655 in persistent memory 220.

FIG. 9 is a functional block diagram of an example data structure showing a second region of an example virtual memory mapping table 520 containing metadata associated with tracks of data stored in a snapshot repository, according to some embodiments. As shown in FIG. 9, in some embodiments the VPI metadata management infrastructure uses a separate page of virtual memory mapping table 520 for each snapshot instance of a customer-provisioned storage volume 500. As data from memory regions of persistent memory 220 are moved from persistent memory 220 to a snapshot repository 400, the locations of the data in the snapshot repository 400 are recorded as entries in the per-snapshot page of virtual memory mapping table 520. Thus, if there are 5 snapshot instances of a given track of a customer-provisioned storage volume, metadata associated with the tracks of data that were copied from persistent memory 220 to snapshot repositories 400 will be managed by the VPI metadata management infrastructure using five separate per-snapshot pages of the virtual memory mapping table 520.

It should be noted that not all tracks of data of a given customer-provisioned storage volume 500 are stored in the snapshot repositories 400. Rather, a track of data is only written out to the snapshot repository 400 when a new version of the track is received that has a snapshot instance identifier that is different than the snapshot instance identifier of the track that is current stored in persistent memory. In this manner, tracks of data of a given customer-provisioned storage volume 500 that are not overwritten continue to be stored in persistent memory 220. Accordingly, receipt of an instruction from a customer to create a new RPO does not cause all tracks of data associated with the previous snapshot instance identifier to be moved from persistent memory 220 to the snapshot repository 400. Rather, individual tracks of data with the previous snapshot instance identifier are only moved from persistent memory 220 to the snapshot repository 400 as new versions of the tracks are received.

There are instances where a customer may wish to roll back to a previous RPO (snapshot) of a customer-provisioned storage volume 500. Since tracks of the snapshot may be contained in both the snapshot repository 400, and persistent memory 220, the storage system will first construct the snapshot instance before loading the snapshot to the host.

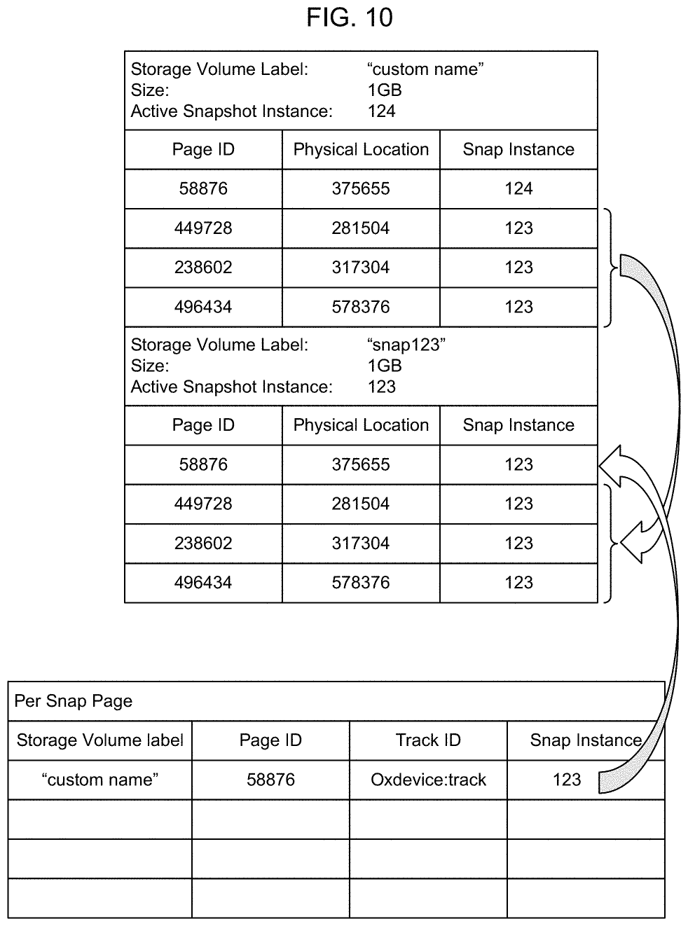

FIG. 10 is a functional block diagram of several data structures showing construction of a snapshot filesystem, where a first portion of the tracks of the snapshot filesystem are stored in persistent memory 220 and a second portion of tracks of the snapshot filesystem are stored in a snapshot repository 400, according to some embodiments. Assume that, as shown in FIG. 10, a given customer-provisioned storage volume has four tracks, and that an instruction is received by the storage system to mount a RPO associated with snapshot instance identifier 123. In this example, three of the tracks associated with snapshot instance identifier 123 are currently stored in persistent memory (tracks with page ID 449728; 238602; and 496434). The fourth track of the customer-provisioned storage volume (with a page ID 58876) that is stored in persistent memory has a snapshot instance identifier 124. Accordingly, to build a snapshot filesystem for snapshot instance identifier 123, the fourth track with page ID 58876 and snapshot instance identifier 123 is retrieved from the snapshot repository 400. The location of the track 58876 in snapshot repository is located using the per-snapshot page of virtual memory mapping table 520 associated with snapshot instance 123.

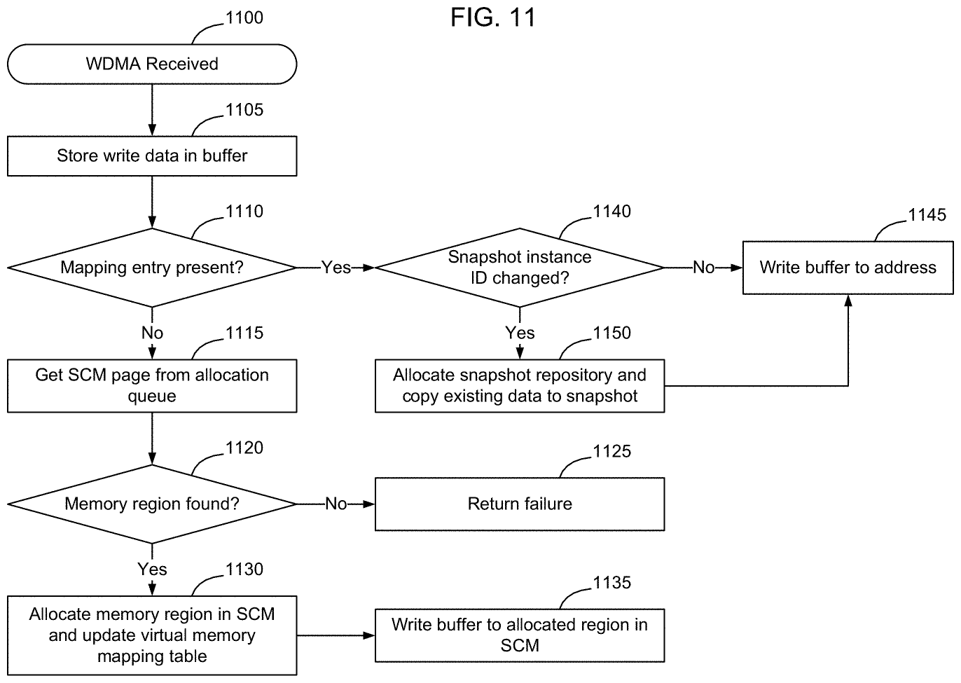

FIG. 11 is a flow chart of an example process of implementing a write operation to persistent memory 220, according to some embodiments. As shown in FIG. 11, when a Direct Memory Access (DMA) write operation (WDMA) is received (block 1100) the data associated with the WDMA operation is stored in a buffer (block 1105). In some embodiments, the buffer is a slot of cache 210.

The data services layer 230 (see FIG. 2) then tries to resolve the location where the write should occur in persistent memory 220. Specifically, the data services layer 230 performs a lookup operation on the virtual memory mapping table 520 to determine if there is an entry in the virtual memory mapping table 520 for the virtual address associated with the WDMA operation (block 1110).

If there is no entry for the virtual address (a determination of NO at block 1110), the WDMA operation is associated with a new track of data of the customer-defined storage volume and a new region of persistent memory 220 will need to be allocated to the WDMA operation. Accordingly, the data services layer 230 will attempt to obtain and allocate a memory region of persistent memory from a page allocation queue (block 1115). If no memory region is found in persistent memory (a determination of NO at block 1120) the data services layer 230 will return a failure (block 1125). If a memory region is found in persistent memory (a determination of YES at block 1120), the data services layer 230 will allocate a page of persistent memory and update the virtual memory mapping table 520 to correlate the virtual address and physical address of the allocated page of persistent memory (block 1130). The snapshot instance identifier associated with the current RPO for the customer-defined storage volume will be included in the entry in the virtual memory mapping table 520. The data associated with the WDMA operation will then be written from the buffer to the allocated memory region in persistent memory (block 1135).

If the data services layer is able to locate an entry for the virtual address in the virtual memory mapping table 520 (a determination of YES at block 1110), the data services layer will read the snapshot instance identifier of the entry to determine the snapshot instance identifier of the version of the data that is currently stored at the memory region in persistent memory (block 1140). The data service layer will then compare the snapshot instance identifier of the version of the data that is currently stored in persistent memory with the snapshot instance identifier of the current RPO for the customer-defined storage volume.

If the snapshot instance of the current RPO is the same as the snapshot instance identifier of the data that is currently stored in persistent memory (a determination of NO at block 1140) the data that is currently stored in persistent memory does not need to be preserved in a snapshot repository 400. Accordingly, a SFENCE/CLFLUSH operation will be issued to cause the data associated with the WDMA to be written to the identified memory region in persistent memory 220, thus causing the new data to overwrite the data that was previously stored at that memory region in persistent memory 220.

If the snapshot instance of the current RPO is not the same as the snapshot instance identifier of the data that is currently stored in persistent memory (a determination of YES at block 1140) the data that is currently stored in persistent memory will need to be preserved by being copied to a snapshot repository. Accordingly, a SFENCESNAP operation is issued to cause the data that is currently stored at the address of persistent memory to be copied to a memory allocation in a snapshot repository 400 (block 1150). After the current data has been copied to the snapshot repository 400, the data associated with the WDMA is written to the identified memory region in persistent memory 220, thus causing the new data to overwrite the data that was previously stored at that memory region of persistent memory (block 1145). Since the previous data has been preserved in a snapshot repository 400, however, the previous data is available in case it is necessary to revert back to an earlier RPO at a subsequent point in time. The virtual memory mapping table 520 is also updated to reflect the current version of the snapshot instance identifier associated with the data stored at the memory region of persistent memory 220.

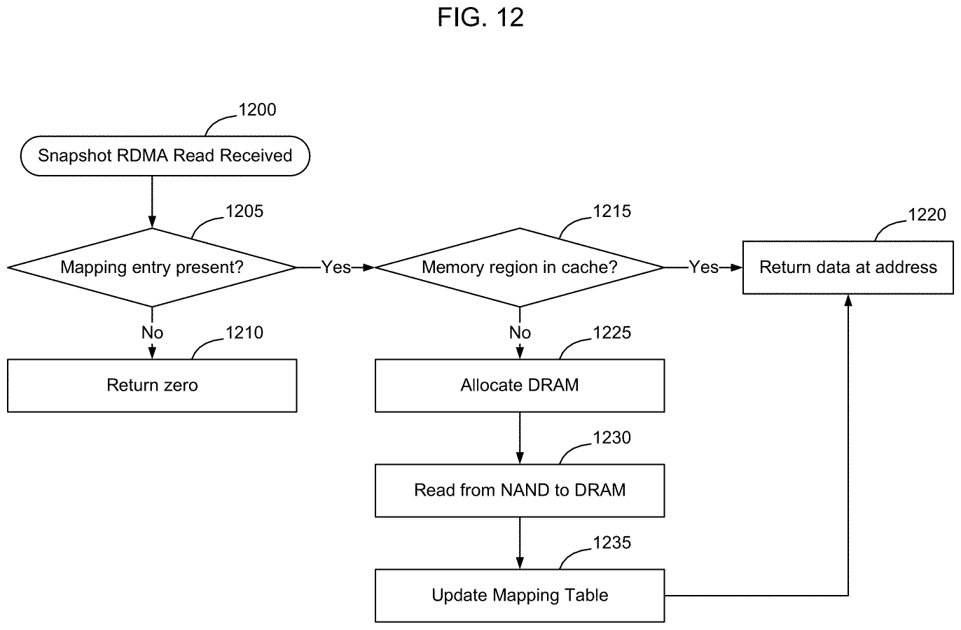

FIG. 12 is a flow chart of an example process of implementing a snapshot read operation where recovery point objectives are implemented using local replication of persistent memory, according to some embodiments. As shown in FIG. 12, if it is desirable to revert back to an earlier RPO by loading a snapshot of a filesystem, a snapshot RDMA read operation will be received by the data services layer 230 (block 1200). The data services layer will determine whether the address of the track of the customer-defined storage volume 500 associated with the RDMA read operation is contained in the virtual memory mapping table 520 (block 1205). If the address of the track does not exist in the virtual memory mapping table 520 (a determination of NO at block 1205) the data services layer 230 will return null (block 1210).

If the address of the track of the customer-defined storage volume 500 is located in the virtual memory mapping table 520 (a determination of YES at block 1205) the data services layer 230 will determine whether the track is stored in cache (block 1215). If the requested memory region is currently stored in the cache (a determination of YES at block 1215) the requested track is read from the cache to fulfill the RDMA operation (block 1220). If the requested track is not currently stored in cache (a determination of NO at block 1215) a slot is allocated in the cache (block 1225). The requested track of the customer-defined storage volume is then read from either its location in persistent memory 220 or from a snapshot repository 400, depending on where the track with the specified snapshot instance identifier associated with the RPO currently resides (block 1230). For example, if the track with the specified snapshot instance identifier resides in persistent memory 220, then the track is read from persistent memory 220. If the track with the specified snapshot instance identifier associated with the RPO is stored in a snapshot repository 400, the track is read from the snapshot repository 400. Once the track is read into the allocated cache slot, the virtual memory mapping table 520 is updated to identify the requested memory region as resident in the cache 210. The requested memory region is then read from the cache (block 1220) to fulfill the RDMA operation.

In some embodiments, the amount of storage on managed drives 132 that is used to implement snapshot repositories 400 is a user-configurable parameter. For example, if there is 30 TB of persistent memory 220 available on storage engines 118 of a given storage system 100, a user may opt to allocate 100 TB of storage on managed drives 132 to be used, as needed, for use as snapshot repositories to store snapshots of tracks of data on the storage system. Of course, the particular amount of persistent memory and the user-selected amount of storage on managed drives 132 that is to be used to implement snapshot repositories 400 will vary, depending on the implementation and user preferences.

By enabling snapshot versioning to be implemented on a per-track basis of a customer-provisioned storage volume 500, and only copying tracks from persistent memory 220 to snapshot repositories 400 on backend managed drives 132 when necessary to preserve earlier versions of data, it is possible to minimize the amount of back-end storage resources required to implement recovery point objectives of the customer-provisioned storage volumes. Specifically, instead of storing a point-in-time version of all changes to a particular customer-provisioned storage volume as a block snapshot, only the changed tracks that are going to be overwritten are moved from persistent memory 220 to snapshot repositories 400 on back-end storage resources. This enables the tracks to be individually backed up as needed, while retaining the current versions of the tracks in persistent memory, which makes the snapshots more granular, by causing only changed memory regions to be stored in snapshot repositories. Thus, persisted instances of individual memory regions can be used to implement an RPO rather than using snapshots implemented as block devices. Further, the snapshot repository may be implemented as a thin device, such that the actual storage resources consumed in managed drives 132 will expand and contract as snapshot data is moved in and out of snapshot repository 400.

The methods described herein may be implemented as software configured to be executed in control logic such as contained in a Central Processing Unit (CPU) or Graphics Processing Unit (GPU) of an electronic device such as a computer. In particular, the functions described herein may be implemented as sets of program instructions stored on a non-transitory tangible computer readable storage medium. The program instructions may be implemented utilizing programming techniques known to those of ordinary skill in the art. Program instructions may be stored in a computer readable memory within the computer or loaded onto the computer and executed on computer's microprocessor. However, it will be apparent to a skilled artisan that all logic described herein can be embodied using discrete components, integrated circuitry, programmable logic used in conjunction with a programmable logic device such as a Field Programmable Gate Array (FPGA) or microprocessor, or any other device including any combination thereof. Programmable logic can be fixed temporarily or permanently in a tangible computer readable medium such as random-access memory, a computer memory, a disk drive, or other storage medium. All such embodiments are intended to fall within the scope of the present invention.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A non-transitory tangible computer readable storage medium having stored thereon a computer program for creating recovery point objectives in persistent memory, the computer program including a set of instructions which, when executed by a computer, cause the computer to perform a method comprising the steps of:
maintaining a virtual memory mapping table data structure, the virtual memory mapping table data structure including entries correlating virtual addresses of tracks of a customer-defined storage volume with physical addresses of memory regions of persistent memory, each entry further including a snapshot instance identifier identifying a recovery point objective of data stored at the respective memory region of persistent memory;
receiving a first write operation to a first track of the customer-defined storage volume;
reading a first entry associated with a first virtual address of the first track from the virtual memory mapping table, to determine a first memory region of the persistent memory where the first track should be stored in persistent memory, and to determine a respective a first snapshot instance identifier;
comparing the first snapshot instance identifier with a current snapshot instance identifier associated with the customer-defined storage volume;
when the first snapshot instance identifier is the same as the current snapshot instance identifier associated with the customer-defined storage volume, writing the first track to the first memory region of persistent memory; and
when the first snapshot instance identifier is not the same as the current snapshot instance identifier associated with the customer-defined storage volume, copying first data from the first memory region of persistent memory to a snapshot repository before writing the first track to the first memory region of persistent memory.

2. The non-transitory tangible computer readable storage medium of claim 1, wherein the snapshot repository is implemented using storage other than the persistent memory.

3. The non-transitory tangible computer readable storage medium of claim 1, further comprising adding an entry to the virtual memory mapping table identifying the first data, a physical address where the first data is stored in the snapshot repository, and the first snapshot instance identifier.

4. The non-transitory tangible computer readable storage medium of claim 1, wherein the persistent memory is implemented using Storage Class Memory (SCM).

5. The non-transitory tangible computer readable storage medium of claim 4, wherein the SCM is configured such that data stored in the SCM is not lost during a power loss event.

6. The non-transitory tangible computer readable storage medium of claim 1, further comprising adding a second entry for the first data identifying a location of the first data in the snapshot repository.

7. A method of creating a recovery point objective in persistent memory, comprising:
storing a plurality of tracks of data of a customer-defined storage volume associated with a first snapshot instance identifier in memory regions of persistent memory;
assigning a second snapshot instance identifier to the customer-defined storage volume; and
implementing a write operation on a first of the memory regions of the persistent memory, the write operation causing data stored in the first memory region to be copied to a snapshot repository, and then new data associated with the write operation to be written to the first memory region.

8. The method of claim 7, wherein the second snapshot instance identifier is associated with the first memory region when the write operation is implemented on the first memory region.

9. The method of claim 7, further comprising maintaining a virtual memory mapping table containing entries correlating the plurality of tracks of data of the customer-defined storage volume with the addresses of the memory regions of persistent memory.

10. The method of claim 9, wherein each entry contains a snapshot instance identifier identifying a snapshot instance identifier of the customer-defined storage volume at the time the data contained at a respective memory region was written to persistent memory.

11. The method of claim 9, wherein the virtual memory mapping table further containing entries specifying locations of tracks in the snapshot repository.

12. The method of claim 7, further comprising:
creating a snapshot filesystem associated with the first snapshot instance identifier by retrieving a first subset of tracks of data of the customer-defined storage volume having the first snapshot identifier from memory regions of the persistent memory, and retrieving a second subset of tracks of data of the customer-defined storage volume having the first snapshot identifier from the snapshot repository.

13. The method of claim 7, wherein the persistent memory is implemented using Storage Class Memory (SCM).

14. The method of claim 13, wherein the SCM is configured such that data stored in the SCM is not lost during a power loss event.

15. A virtual memory mapping table data structure, comprising:
a plurality of entries correlating virtual addresses of tracks of a customer-defined storage volume with physical addresses of memory regions of persistent memory, each entry further including a snapshot instance identifier identifying a recovery point objective of data stored at the respective memory region of persistent memory.

16. The virtual memory mapping table data structure of claim 15, wherein at least some of the plurality of entries contain different snapshot instance identifiers.

17. The virtual memory mapping table data structure of claim 15, wherein the virtual memory mapping table further comprises a first snapshot page containing entries identifying memory regions of a snapshot repository, each entry being associated with a particular track of data of the customer-defined storage volume that has a first snapshot instance identifier.

18. The virtual memory mapping table data structure of claim 17, wherein the snapshot repository is implemented using storage other than the persistent memory.

19. The virtual memory mapping table data structure of claim 15, wherein the persistent memory is implemented using Storage Class Memory (SCM).

20. The virtual memory mapping table data structure of claim 19, wherein the SCM is configured such that data stored in the SCM is not lost during a power loss event.
